(19) United States
(12) Patent Application Publication
(10) Pub. No.: US 2014/0295784 A1
(43) Pub. Date: Oct. 2, 2014

(54) APPARATUS AND METHOD FOR SWITCHING A COMMUNICATION SCHEME

(71) Applicant: FUJITSU LIMITED, Kawasaki-shi (JP)

(72) Inventor: Naritoshi SAITO, Hino (JP)

(73) Assignee: FUJITSU LIMITED, Kawasaki-shi (JP)

(21) Appl. No.: 14/209,293

(22) Filed: Mar. 13, 2014

(30) Foreign Application Priority Data
Mar. 29, 2013 (JP) 2013-075353

(51) Int. Cl. H04W 4/22; H04W 88/06

(52) U.S. Cl. CPC H04W 4/22; H04W 88/06
USPC 455/404.1

(57) ABSTRACT

A terminal includes a communication device and a processor connected to the communication device. The communication device is configured to conform to first and second communication schemes where the second communication scheme enables communication at a higher communication speed than the first communication scheme and has a narrower service area than the first communication scheme. The processor switches a prioritized scheme from the second communication scheme to the first communication scheme in a case where some of a plurality of signals including emergency information and sequentially notified according to each of the first and second communication schemes are received by the communication device when the prioritized scheme to be preferentially used is the second communication scheme, and returns the prioritized scheme from the first communication scheme to the second communication scheme in a case where the signal is not received for a predetermined time period in the first communication scheme.

### CROSS-REFERENCE TO RELATED APPLICATION

This application is based upon and claims the benefit of priority from the prior Japanese Patent Application No. 2013-075353 filed on Mar. 29, 2013, the entire contents of which are incorporated herein by reference.

### FIELD

The present disclosure relates to apparatus and method for switching a communication scheme.

### BACKGROUND

Recently, various communication schemes such as CDMA (Code Division Multiple Access) 2000 (registered trademark), CDMA2000 1x, and CDMA2000 1xEVDO (Evolution-Data Only) have been proposed as 3G (3rd Generation) mobile communication schemes. CDMA2000 1x is one of technical specifications included in the CDMA2000 standard. In the following, CDMA2000 1x may be simply referred to as “1x”. Further, CDMA2000 1xEVDO is a standard which has been improved from the 1x scheme to be specialized as a packet communication and speed up the communication speed. In the following, CDMA2000 1xEVDO may be simply referred to as “EVDO”.

Further, as the amount of data to be transferred increases with multimedia, packet communication scheme has been developed with which data can be transmitted and received at a higher communication speed. Such a packet communication scheme may include a 3GPP LTE (registered trademark) (3rd Generation Partnership Project Radio Access Network Long Term Evolution) scheme, or a WiMAX (registered trademark) (Worldwide Interoperability for Microwave Access) scheme as an example. In the following, the 3GPP LTE may be simply referred to as “LTE”. In the LTE, a packet communication scheme using OFDMA (Orthogonal Frequency Division Multiplexing Access) has been proposed.

The 1x scheme and the EVDO scheme are communication services that have been widely distributed recently. Therefore, many base stations are installed and a service area thereof, that is, a communication area is very large. In contrast, the LTE scheme and the WiMAX scheme are relatively new services compared to the 1x scheme. Accordingly, the service area of the LTE scheme or the WiMAX scheme is a narrower area, included in a service area of the 1x scheme or the EVDO scheme, with a city as the center. Here, a service area of a communication scheme refers to an area where communication may be enabled in the entire network which conforms to the communication scheme.

Under such circumstances, a multi-mode communication terminal that is able to support a plurality of communication schemes such as, the 1x scheme, the EVDO scheme, and the LTE scheme, has been provided as a communication terminal of a portable telephone. The multi-mode communication terminal may select a communication mode through which the multi-mode communication terminal is preferentially connected to a communication system which conforms to a high speed packet communication scheme, such as the LTE scheme or the WiMAX scheme.

However, people have become alert more and more to disasters resulting from, for example, an earthquake. In order to minimize damages caused by the disasters, for example, a service called ETWS (Earthquake and Tsunami Warning System) has begun with the LTE system. The ETWS is a service which repeatedly notifies information (hereinafter, simply referred to as “emergency information”) about an emergency such as an earthquake or a tsunami, to the communication terminal which is being connected to the LTE system. Further, a service which repeatedly notifies emergency information using a Broadcast SMS (Short Message Service) has also begun with the 1x system. Accordingly, the emergency information may be notified to a communication terminal being connected to the 1x system. With these services, a user can quickly recognize the occurrence of an emergency and be kept informed of an every-changing situation. Therefore, the damages caused by the disaster may be suppressed to the minimum level.

Japanese Patent Application Laid-Open No. 2011-176641 has been known as an example of the prior art.

### SUMMARY

In the aspect of the present disclosure, a communication terminal includes a communication device and a processor connected to the communication device. The communication device is configured to conform to a first communication scheme and a second communication scheme that enables communication at a higher communication speed than the first communication scheme and has a narrower service area than the first communication scheme. The processor switches a prioritized scheme from the second communication scheme to the first communication scheme in a case where some of a plurality of signals including emergency information and sequentially notified according to each of the first communication scheme and the second communication scheme are received by the communication device when the prioritized scheme to be preferentially used is the second communication scheme, and returns the prioritized scheme from the first communication scheme to the second communication scheme in a case where the signal is not received for a predetermined time period in the first communication scheme.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

### BRIEF DESCRIPTION OF DRAWINGS

FIG. 1 is a schematic diagram illustrating an exemplary communication system according to an embodiment 1.

FIG. 2 is a block diagram illustrating an exemplary terminal of the embodiment 1.

FIG. 3 is a schematic diagram illustrating an exemplary communication system according to an embodiment 2.

FIG. 4 is an explanatory diagram illustrating an example of relationship between a communication area of the 1x scheme/EVDO scheme and a communication area of the LTE scheme.

FIG. 5 is a block diagram illustrating an exemplary terminal of the embodiment 2.

FIG. 6 is a diagram illustrating an example of a configuration of a primary notification.

FIG. 7 is a diagram for explaining an example of a configuration of a serial number.

FIG. 8 is a diagram illustrating a usage example of a GS code.

FIG. 9 is a diagram illustrating an example of a configuration of a warning type.

FIG. 10 is a diagram for explaining a usage example of a message ID and the warning type.

FIG. 11 is a diagram illustrating an example of a configuration of a secondary notification.

FIG. 12 is a diagram illustrating an example of the content of message.

FIG. 13 is a diagram illustrating an example of a configuration of a broadcast SMS.

FIG. 14 is a diagram for explaining transmission of paging message including an ETWS notification.

FIG. 15 is a flowchart illustrating an example of processing operations of the terminal of the embodiment 2.

FIG. 16 is a diagram illustrating an example of the contents displayed on a display unit.

FIG. 17 is a diagram illustrating an example of an association table.

FIG. 18 is a diagram illustrating another example of the contents displayed on the display unit.

FIG. 19 is a diagram for explaining a timer update.

FIG. 20 is a flowchart illustrating a modified example of processing operations of the terminal.

FIG. 21 is a diagram illustrating an example of correspondence relationship upon receiving the ETWS information.

FIG. 22 is a diagram illustrating an example of a correspondence relationship in normal times.

FIG. 23 is a diagram illustrating a modified example of the correspondence relationship upon receiving the ETWS information.

FIG. 24 is a diagram illustrating a modified example of the correspondence relationship in normal times.

FIG. 25 is an explanatory diagram illustrating a terminal which executes a control program.

### DESCRIPTION OF EMBODIMENTS

However, when a target system for connection of a communication terminal is switched as the communication terminal moves, the connection condition of the communication terminal may become unstable compared to, for example, a case of handover in the same system. With the instability, the communication terminal may not be able to receive important information stably. In the meantime, even when the service area is narrow, the communication according to a communication scheme which is capable of supporting a high speed communication provides the user with a high convenience.

In the following, embodiments of the communication terminal, the communication method and the control program disclosed in the present application will be described in detail based on the drawings. Further, the communication terminal, the communication method and the control program disclosed in the present application are not limited to the embodiments. Further, similar constitutional elements having similar functions are denoted by similar reference numerals, and redundant descriptions thereof will be omitted.

### Embodiment 1

### Summary of Communication System

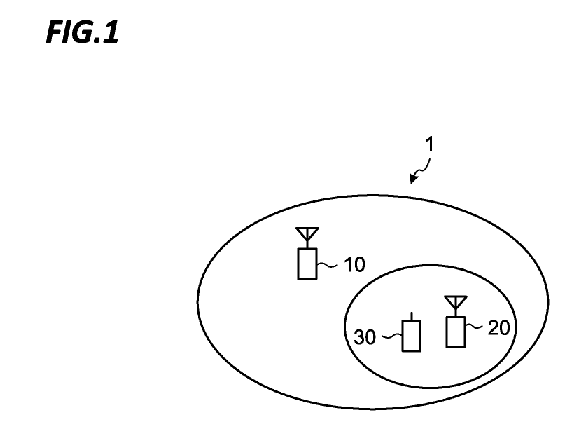

FIG. 1 is a schematic diagram illustrating an exemplary communication system according to an embodiment 1. In FIG. 1, a communication system 1 includes base stations 10, 20 and a communication terminal 30. In the following, a communication terminal is simply referred to as a “terminal”.

The base station 10 belongs to a first communication system and communicates with the terminal 30 using the first communication scheme. In the meantime, the base station 20 belongs to a second communication system and communicates with the terminal 30 using the second communication scheme.

Here, the service area of the first communication system (i.e., the service area of the first communication scheme) is wider than the service area of the second communication system (i.e., the service area of the second communication scheme). That is, for example, the service area of the first communication system expands nationwide while the service area of the second communication system is concentrated on the urban area. Further, the service area of the first communication system refers to an area within which communication may be enabled in the entirety of the first communication system. That is, the service area of the first communication system may be regarded as an area formed by summing up the coverage areas of all the base stations 10 which conform to the first communication system. Furthermore, the service area of the second communication system refers to an area within which communication may be enabled in the entirety of the second communication system. That is, the service area of the second communication system may be regarded as an area formed by summing up the coverage areas of all the base stations 20 which conform to the second communication system.

Furthermore, the communication speed of the second communication scheme is faster than the communication speed of the first communication scheme.

Furthermore, an emergency information notification service is performed in both of the first communication system and the second communication system. That is, for example, when an earthquake occurs, there is a possibility that a signal including emergency information may be transmitted repeatedly from each of the base station 10 of the first communication system and the base station 20 of the second communication system. The emergency information indicates that an emergency such as an earthquake or a tsunami has occurred and is information used by the terminal 30 to urge a user to pay attention.

The terminal 30 may be configured to be connected to both the first communication system and the second communication system. Also, the terminal 30 is configured in such a manner that a “prioritized scheme” used preferentially is set as the second communication scheme in normal times. That is, when the terminal 30 is located in an overlapped area of the first service area and the second communication area, the terminal 30 preferentially connects to the base station 20 using the second communication scheme. In the meantime, when the terminal 30 belongs to the first service area and is located in an area outside of the second communication area, the terminal 30 is not able to connect to the base station 20 and thus, connects to the base station 10.

Also, in a case where a signal which includes emergency information and may be repeatedly transmitted from the base station according to each of the first communication scheme and the second communication scheme, is received when the prioritized scheme is the second communication scheme, the terminal 30 switches the prioritized scheme from the second communication scheme to the first communication scheme. Furthermore, when a predetermined condition is satisfied, the terminal 30 returns the prioritized scheme from the first communication scheme to the second communication scheme. The predetermined condition indicates, for example, that the signal including the emergency information described above is not received within a predetermined period of time in the first communication scheme. A starting point of the predetermined period of time, that is, a reference timing corresponds to a switching timing when it is immediately after switching from the second communication scheme to the first communication scheme. Also, when the signal including the emergency information is received until the predetermined time elapses after the switching timing, the reception time point becomes a new reference timing. That is, the terminal 30 manages determination timing used for determining as to whether the predetermined condition is satisfied, that is, as to whether a setting scheme is to be returned from the first communication scheme to the second communication scheme. Here, the determination timing corresponds to a timing after the predetermined time has expired from the reference timing, that is, an ending point of the predetermined period of time.

That is, the terminal 30 connects preferentially to the second communication system until the signal which includes emergency information and may be repeatedly transmitted from the base station according to each of the first communication scheme and the second communication scheme is received. In the meantime, the terminal 30 connects preferentially to the first communication system after the signal which includes emergency information and may be repeatedly transmitted from the base station according to each of the first communication scheme and the second communication scheme is received.

Further, the first communication scheme is, for example, the 1x scheme, and the second communication scheme is, for example, the LTE scheme.

As described above, in a case where a communication device receives a signal which includes emergency information and may be repeatedly transmitted from the base station according to each of the first communication scheme and the second communication scheme when the second communication scheme is the prioritized scheme, the terminal 30 switches the prioritized scheme to the first communication scheme. As such, a communication scheme is preferentially switched to the first communication scheme having a wider service area and thus, the frequency of occurring switching of a target system for connection (hereinafter, simply referred to as “system switching”) may be reduced. Also, the terminal 30 may wait for the emergency information after the occurrence frequency of the system switching is reduced and thus, the emergency information may be stably received and the reception failure of the emergency information may be prevented.

Furthermore, when the predetermined condition is satisfied, the terminal 30 returns the prioritized scheme from the first communication scheme to the second communication scheme. Accordingly, for example, when there is no need to receive the emergency information, the communication scheme may be returned to the second communication scheme having a higher communication speed and thus, user convenience may be prevented from being reduced.

Further, descriptions have been made on a case where the number of communication scheme available for the terminal 30 is two, but the number of available communication schemes is not limited by two.

[Terminal Configuration]

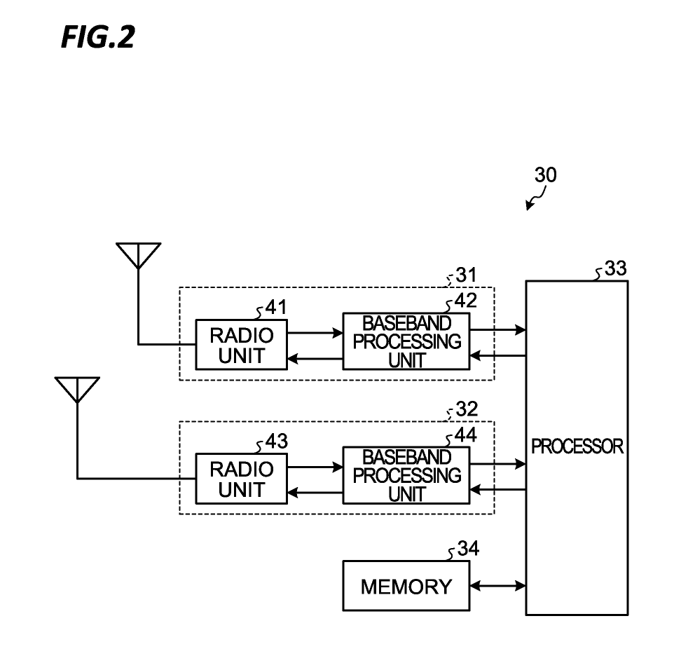

FIG. 2 is a block diagram illustrating an exemplary terminal of the embodiment 1. In FIG. 2, the terminal 30 includes communication devices 31, 32, a processor 33, and a memory 34. An example of the processor 33 may include, for example, a CPU (Central Processing Unit), a DSP (Digital Signal Processor), and a FPGA (Field Programmable Gate Array). Furthermore, an example of the memory 34 may include, for example, a RAM (Random Access Memory), such as a SDRAM (Synchronous Dynamic Random Access Memory), a ROM (Read Only Memory), and a flash memory. Furthermore, the communication devices 31, 32 may be implemented by LSI (Large Scale Integration).

The communication device 31 conforms to the first communication scheme. Also, when the setting scheme of the communication device 31 becomes the first communication scheme by instruction from the processor 33, the communication device 31 performs communication using the first communication scheme. That is, the setting scheme is a communication scheme actually used by the terminal 30.

For example, the communication device 31 includes a radio unit 41 and a baseband processing unit 42. The radio unit 41 receives a radio signal according to the first communication scheme via an antenna and performs a frequency conversion on the received radio signal. The baseband processing unit 42 converts the signal obtained from the radio unit 41 into a baseband signal and demodulates the converted baseband signal. Furthermore, the baseband processing unit 42 modulates data received from the processor 33 into a baseband signal for transmission. The radio unit 41 performs a frequency conversion on the baseband signal obtained from the baseband processing unit 42, and transmits the converted radio signal via the antenna.

The communication device 32 conforms to the second communication scheme. Also, when the setting scheme of the communication device 32 becomes the second communication scheme by instruction from the processor 33, the communication device 32 performs communication using the second communication scheme.

The communication device 32 includes a radio unit 42 and a baseband processing unit 44. The radio unit 43 receives a radio signal according to the second communication scheme via an antenna and performs a frequency conversion on the received radio signal. The baseband processing unit 44 converts the signal obtained from the radio unit 43 into a baseband signal and demodulates the converted baseband signal. Furthermore, the baseband processing unit 44 modulates data received from the processor 33 into a baseband signal for transmission. The radio unit 43 performs a frequency conversion on the baseband signal obtained from the baseband processing unit 44, and transmits the converted radio signal via the antenna.

The processor 33 is configured such that the second communication scheme is set as “prioritized scheme” in normal times. Also, when the terminal 30 is located within the second service area, the processor 33 sets the second communication scheme which is the prioritized scheme as the setting scheme. In contrast, when the terminal 30 is located outside of the second service area, the terminal 30 is not able to connect to the base station 20 which conforms to the second communication scheme which is the prioritized scheme and thus, the processor 33 sets the first communication scheme as the setting scheme. Here, a determination as to whether the terminal 30 is located within the first service area is determined based on whether a known signal transmitted from the base station 10 may be received by the terminal 30 at a predetermined signal strength level or more. Similarly, a determination as to whether the terminal 30 is located within the second service area is determined based on whether a known signal transmitted from the base station 20 may be received by the terminal 30 at a predetermined signal strength level or more. Furthermore, a communication device which is not in conformity with the setting scheme becomes basically OFF state, but needs reception of the known signal. Therefore, the communication device becomes temporarily ON state at predetermined intervals.

When the signal which includes the emergency information is received by the communication device which conforms to the setting scheme, the processor 33 switches the prioritized scheme from the second communication scheme to the first communication scheme. According to switching of the prioritized scheme, when the terminal 30 is located within the second service area, the processor 33 performs switching of the setting scheme from the second communication scheme to the first communication scheme. Further, when the terminal 30 is located outside of the second service area, the setting scheme is already set as the first communication scheme and thus, switching of the setting scheme is not performed.

Furthermore, when the predetermined condition is satisfied, the processor 33 returns the prioritized scheme from the first communication scheme to the second communication scheme. Accordingly, when the terminal 30 is located within the second service area, the processor 33 switches the setting scheme from the first communication scheme to the second communication scheme. Here, the predetermined condition indicates that the signal including the emergency information described above is not received within the predetermined period of time in the first communication scheme.

Specifically, when the prioritized scheme is switched from the second communication scheme to the first communication scheme, the processor 33 starts counting for a predetermined time. Also, when the signal which includes emergency information is received according to the setting scheme within the predetermined period of time until the predetermined time expires, the processor 33 starts counting for the predetermined time by setting the reception time point as a new reference time point. That is, the processor 33 updates the starting point of the predetermined period of time each time when the signal which includes the emergency information is received according to the setting scheme. Also, when the signal which includes emergency information is not received for the predetermined period of time, the processor 33 returns the prioritized scheme from the first communication scheme to the second communication scheme. Here, the processor 33 may set the predetermined time, that is, the length of the predetermined period of time according to the type of emergency indicated by emergency information or the type of the emergency information.

The memory 34 stores various programs and various data used by the processor 33. The program stored in the memory 34 is read and executed by the processor 33 and thus, various processes are implemented by the processor 33.

As described above, according to the embodiment, in a case where the signal which includes emergency information is received in the terminal 30 when the prioritized scheme is the second communication scheme, the processor 33 switches the prioritized scheme from the second communication scheme to the first communication scheme.

With the configuration as described above, the terminal 30 may switch to the first communication scheme having the larger service area and wait for the emergency information and thus, the reception failure of emergency information may be prevented.

Furthermore, when the predetermined condition is satisfied, the processor 33 returns the prioritized scheme from the first communication scheme to the second communication scheme. The predetermined condition indicates that the signal including the emergency information is not received within the predetermined period of time described above according to the setting scheme.

With the configuration of the terminal 30, for example, when the receiving of the emergency information is no longer required, the terminal 30 can be returned to the second communication scheme having a higher communication speed. Accordingly, the inconvenience caused by remaining in the first communication scheme having a lower communication speed may be prevented.

Furthermore, the processor 33 sets the length of the predetermined period of time according to the type of emergency indicated by the emergency information or the type of emergency information. For example, the processor 33 sets the predetermined period of time to be longer as an importance level for each type of emergency (e.g., a degree of risk or a degree of urgency) becomes higher. Otherwise, the processor 33 sets the predetermined period of time to be longer as an importance level for each type of emergency information (e.g., a degree of risk or a degree of urgency) becomes higher.

With the configuration of the terminal 30, for example, the predetermined period of time according to an importance level for each type of emergency (e.g., a degree of risk or a degree of urgency) may be set and thus, the possibility that the reception failure of emergency information having a high degree of importance occurs may be reduced.

Furthermore, the processor 33 updates the starting point of the predetermined period of time each time when the signal which includes the emergency information is received according to the first communication scheme.

With the configuration of the terminal 30, the terminal 30 receives the signal which includes the emergency information and thus, can set up a standby state for the signal which includes next emergency information which becomes to have a higher chance for reception. Further, the length of the predetermined period of time together with the starting point may also be updated each time when the signal which includes the emergency information is received according to the first communication scheme.

### Embodiment 2

The embodiment 2 relates to a specific example of the communication system 1 described in the embodiment 1. That is, in the following, descriptions will be made on a case where the communication system 1 is a multi-mode wireless communication system which is conformable to the 1x scheme, the EVDO scheme and the LTE scheme, as an example.

[Example of Communication System Configuration]

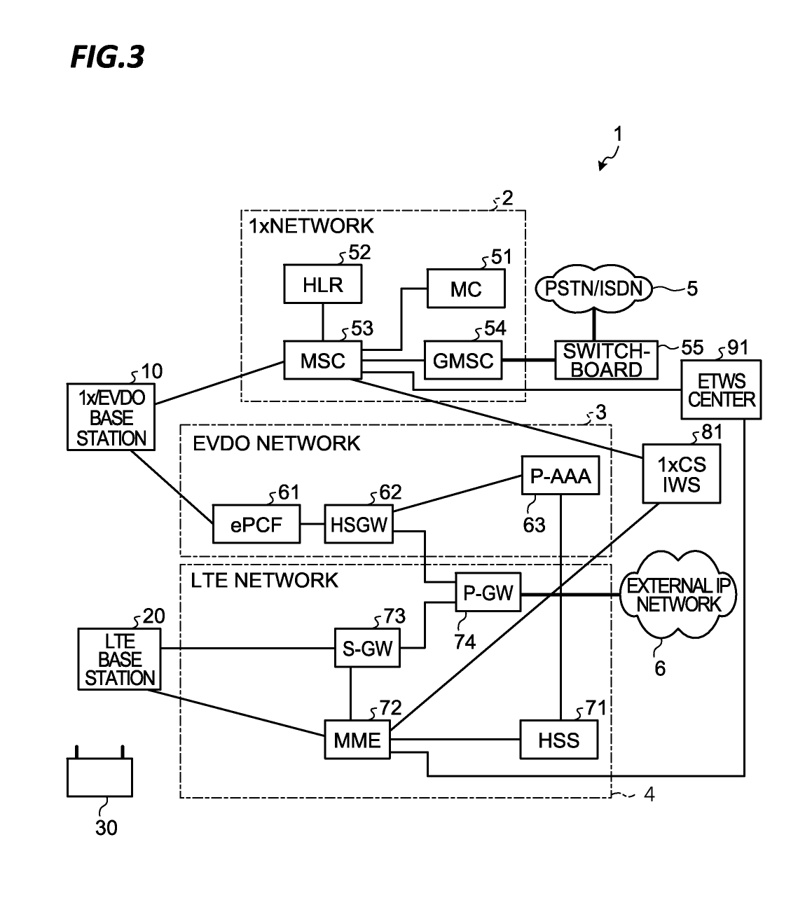

FIG. 3 is a diagram illustrating an example of the communication system according to an embodiment 2. In FIG. 3, the communication system 1 includes the 1x network 2, the EVDO network 3 and the LTE network 4. The communication system 1 includes a PSTN (Public Switched Telephone Network)/ISDN (Integrated Services Digital Network) 5 and an external IP (Internet Protocol) network 6. Furthermore, the communication system 1 includes the base stations 10, 20 and the terminal 30.

The 1x network 2 includes a MC (Message Center) 51, a HLR (Home Location Register) 52, a MSC (Mobile Switching Center) 53 and a GMSC (Gateway Mobile Switching Center) 54. The MC 51 distributes, for example, a message. The HLR 52 registers and manages subscriber information, location information, and authentication information of the service subscriber within the 1x network 2, in association with each other. The MSC 53 is switchingly connected with the respective base stations 10. The GMSC 54 is switchingly connected with the MSC 53 and a switchboard 55 connected with the PSTN/ISDN 5.

The EVDO network 3 includes an ePCF (evolved Packet Control Function) 61, a HSGW (High Rate Packet Data Serving Gateway) 62, and a P-AAA (Proxy-Authentication, Authorization and Accounting) 63. The ePCF 61 is connected with the base station 10 to route packets. The HSGW 62 converts the packets into a high-speed packet data for the EVDO scheme. The P-AAA 63 manages authentication, approval, and accounting on the subscriber within the EVDO network 3.

The LTE network 4 includes a HSS (Home Subscriber Server) 71, a MME (Mobility Management Entity) 72, a S-GW (Serving-Gateway) 73, and a P-GW (Packet Data Network Gateway) 74. The HSS 71 manages, for example, information of the subscriber within the LTE network 4. The MME 72 connects the base station 20 and the S-GW 73, and is responsible for a network control, such as a sequence control in the LTE network 4, handover signaling function, location information management of the service subscriber, and paging signaling function of the terminal to the base station 20 upon incoming call arrival. The S-GW 73 is connected with the base station 20 to route the packet. The P-GW 74 is a gateway which communicably connects a HSGW 62 within the EVDO network 3, the external IP network 6, and the S-GW 73. The P-GW 74 seamlessly performs the packet communication between, for example, the EVDO network 3 and the LTE network 4. Furthermore, the HSS 71 and the P-AAA 63 are used with being shared by the EVDO network 3 and the LTE network 4.

A 1xCS IWS (1x Circuit Switched Interworking Solution) 81 switchingly connects the MSC 53 within the 1x network 2 and the MME 72 within the LTE network 4.

The ETWS center 91 generates a signal which includes ETWS information upon, for example, occurrence of an earthquake, and transmits the generated signal to both the MSC 53 within the 1x network 2 and the MME 72 within the LTE network 4. The ETWS center 91 is, for example, a server which executes a process related to ETWS. Details of ETWS will be described in more detail later.

The base station 10 is a 1x/EVDO station conformable to both the 1x scheme and the EVDO scheme. When the signal which includes ETWS information is received through the MSC 53 within the 1x network 2, the base station 10 notifies the terminal 30 located within the coverage area of the base station 10 of the received signal using the 1x scheme. For example, the base station 10 notifies the terminal 30 of the ETWS information using a broadcast SMS including the ETWS information.

The base station 20 is an LTE base station conformable to the LTE scheme. When the signal which includes ETWS information is received through the MME 72 within the LTE network 4, the base station 20 notifies the terminal 30 located within the coverage area of the base station 20 of the received signal using the LTE scheme. For example, the base station 20 notifies the terminal 30 of the ETWS information using SIB (System Information Block).

The terminal 30 is configured such that the LTE scheme is set as the prioritized scheme in normal times. Also, when the signal which includes the ETWS information and may be repeatedly transmitted from the base station according to each of the 1x scheme and the LTE scheme is received by the communication device which conforms to the setting scheme when the prioritized scheme is the LTE scheme, the terminal 30 switches the prioritized scheme from the LTE scheme to the 1x scheme. That is, the terminal 30 is preferentially connected to the LTE system until the signal which includes the ETWS information and may be repeatedly transmitted from the base station according to each of the 1x scheme and the LTE scheme is received. In the meantime, the terminal 30 is preferentially connected to the 1x system after the signal which includes the ETWS information and may be repeatedly transmitted from the base station according to each of the 1x scheme and the LTE scheme is received. Accordingly, the terminal 30 may switch to the 1x scheme having the wider service area and wait for the ETWS information and thus, the reception failure of ETWS information may be prevented.

Further, when the predetermined condition is satisfied, the terminal 30 returns the prioritized scheme from the 1x scheme to the LTE scheme. The predetermined condition indicates that the signal including the emergency information described above is not received for the predetermined period of time in, for example, the 1x scheme. Accordingly, when there is no need to receive the ETWS information, the communication scheme may be returned to the LTE scheme having a higher communication speed and thus, user convenience may be prevented from being reduced.

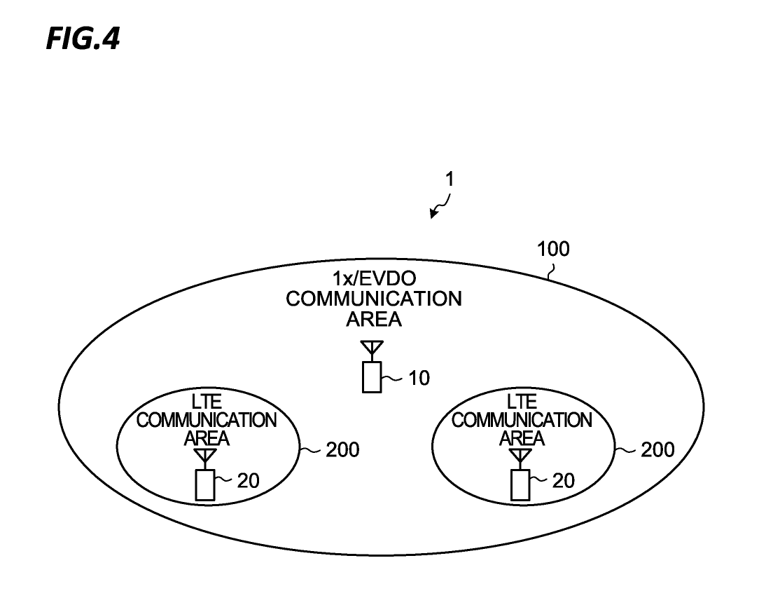

Here, an example of relationship between the communication area of the 1x scheme/EVDO scheme and the communication area of the LTE scheme will be described. FIG. 4 is an explanatory diagram illustrating an example of relationship between a communication area of the 1x scheme/EVDO scheme and a communication area of the LTE scheme.

The communication system 1 illustrated in FIG. 4 includes a communication area 100 of the 1x scheme/EVDO scheme and a communication area 200 of the LTE scheme. The communication area 100 of the 1x scheme/EVDO scheme is a communication area of a service being widespread and provided in recent years. Further, a voice communication service and a packet communication service are provided in the communication area 100 of the 1x scheme/EVDO scheme. Furthermore, the communication area 200 of the LTE scheme is a communication area of a relatively new service as compared to the communication according to the 1x scheme/EVDO scheme, and a packet communication service may be provided mainly on a highly populated urban area. Therefore, the communication area 200 of the LTE scheme is narrower than the communication area 100 of the 1x/EVDO scheme. Furthermore, a high speed packet communication service is provided in the communication area 200 of the LTE scheme. The base station 10 which corresponds to the 1x/EVDO base station is installed in the communication area 100 of the 1x scheme/EVDO scheme. Furthermore, the base station 20 which corresponds to the LTE scheme is installed in the communication area 200.

[Terminal Configuration]

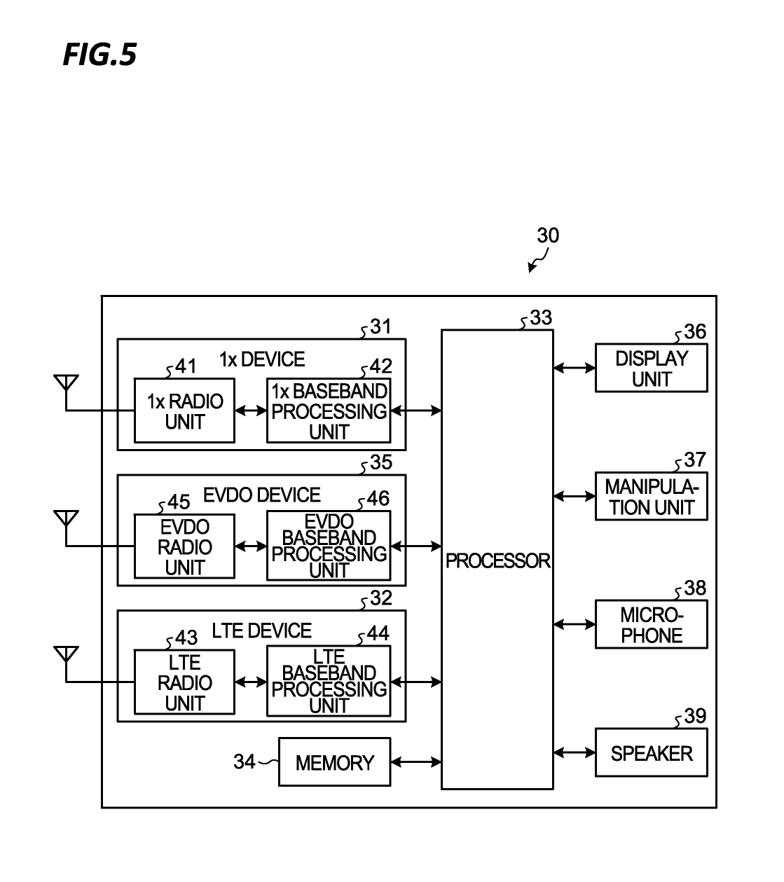

FIG. 5 is a block diagram illustrating an exemplary terminal of the embodiment 2. In FIG. 5, the terminal 30 includes communication devices 31, 32, 35, a processor 33, a memory 34, a display unit 36, a manipulation unit 37, a microphone 38, and a speaker 39. The communication device 31 includes a radio unit 41 and a baseband processing unit 42. The communication device 31 is a 1x communication device which conforms to the 1x scheme in the embodiment 2. The radio unit 41 is an 1x radio unit which conforms to the 1x scheme, and the baseband processing unit 42 is a 1x baseband processing unit which conforms to the 1x scheme. Furthermore, the communication device 32 includes a radio unit 43 and a baseband processing unit 44. The communication device 32 is an LTE communication device which conforms to the LTE scheme in the embodiment 2. The radio unit 43 is an LTE radio unit which conforms to the LTE scheme, and the baseband processing unit 44 is a LTE baseband processing unit which conforms to the LTE scheme. Furthermore, the communication device 35 includes a radio unit 45 and a baseband processing unit 46. The communication device 35 is an EVDO communication device which conforms to the EVDO scheme in the embodiment 2. The radio unit 45 is an EVDO radio unit which conforms to the EVDO scheme, and the baseband processing unit 46 is an EVDO baseband processing unit which conforms to the EVDO scheme. In the following, the communication devices 31, 32, 35 are referred to as the 1x communication device 31, the LTE communication device 32, and the EVDO communication device 35, respectively. Furthermore, the radio units 41, 43, 45 are referred to as the 1x radio unit 41, the LTE radio unit 43, and the EVDO radio unit 45, respectively. Furthermore, the baseband processing units 42, 44, 46 are referred to as the 1x baseband processing unit 42, the LTE baseband processing unit 44, and the EVDO baseband processing unit 46, respectively.

The 1x communication device 31 is an interface for a wireless communication between the terminal 30 and the 1x network 2. The 1x radio unit 41 receives radio signal of various data such as a voice or text based on the 1x scheme via an antenna and performs a frequency conversion on the received radio signal. The 1x baseband processing unit 42 converts the signal which has been subjected to the frequency conversion in the 1x radio unit 41 into a baseband signal, and demodulates the converted baseband signal. Furthermore, the 1x baseband processing unit 42 modulates data to be transmitted into the baseband signal. The 1x radio unit 41 performs the frequency conversion on the baseband signal modulated by the 1x baseband processing unit 42 and transmits the converted signal for transmission through the antenna.

The LTE communication device 32 is an interface for a wireless communication between the terminal 30 and the LTE network 4. The LTE radio unit 43 receives radio signal of various data such as a voice or text based on the LTE scheme via an antenna and performs a frequency conversion on the received radio signal. The LTE baseband processing unit 44 converts the signal which has been subjected to the frequency conversion in the LTE radio unit 43 into a baseband signal and demodulates the converted baseband signal. Furthermore, the LTE baseband processing unit 44 modulates data to be transmitted to the baseband signal. The LTE radio unit 43 performs the frequency conversion on the baseband signal modulated by the LTE baseband processing unit 44 and transmits the converted signal for transmission through the antenna.

The EVDO communication device 35 is an interface for a wireless communication between the terminal 30 and the EVDO network 3. The EVDO radio unit 43 receives the radio signal of various data such as a voice or text based on the EVDO scheme via an antenna and performs a frequency conversion on the received radio signal. The EVDO baseband processing unit 46 converts the signal which has been subjected to the frequency conversion in the EVDO radio unit 45 into a baseband signal and demodulates the converted baseband signal. Furthermore, the EVDO baseband processing unit 46 modulates data to be transmitted to the baseband signal. The EVDO radio unit 45 performs the frequency conversion on the baseband signal modulated by the EVDO baseband processing unit 46 and transmits the converted signal for transmission through the antenna.

The display unit 36 is an output interface for displaying various information on a screen. The manipulation unit 37 is an input interface for inputting various information. The microphone 38 is an input interface for receiving various voices. The speaker 39 is an output interface for outputting voice in audio.

The processor 33 is configured such that the LTE scheme is set as the “prioritized scheme” in normal times. Also, when the terminal 30 is located within the LTE service area, the processor 33 sets the LTE scheme which is currently the prioritized scheme as a setting scheme. In contrast, when the terminal 30 is located outside of the LTE service area, the terminal 30 is not able to be connected to the base station 20 which conforms to the LTE communication scheme which is the prioritized scheme and thus, the processor 33 sets the 1x scheme as the setting scheme.

For example, when the terminal 30 is located within the LTE service area, the processor 33 turns ON the LTE communication device 32 at predetermined intervals to receive PI (Paging Indication). A case where the terminal 30 is located within the LTE service area indicates, for example, a case where the terminal 30 is in a standby state by the LTE scheme. The predetermined interval is, for example, an interval of 1.12 sec. Further, when the terminal 30 is located within the LTE service area, that is, the terminal 30 is being connected with the base station 20, the 1x communication device 31 and the EVDO device 35 are basically in an OFF state. However, the 1x communication device 31 and the EVDO device 35 need to receive known signal from the base station 10 and thus, the 1x communication device 31 and the EVDO device 35 are temporarily turned ON at predetermined intervals.

Also, the processor 33 determines the content of the PI and executes a process according to the content of the PI. The content of the PI includes, for example, an incoming call notification or an ETWS notification to the terminal 30. For example, when the content of the PI corresponds to the ETWS notification, the processor 33 keeps the ON state of the LTE communication device 32 and receives the SIB (System Information Block) transmitted from the base station 20 by being mapped onto a predetermined wireless resource. Specifically, the processor 33 receives SIB 10 (System Information Block Type 10) and SIB 11 (System Information Block Type 11). The SIB 10 includes the Primary Notification and the SIB 11 includes the Secondary Notification. The system information block is a signal which includes ETWS information and is repeatedly transmitted while the ETWS transmits the ETWS information.

Furthermore, in a case where the communication device which conforms to the setting scheme receives the signal which includes the ETWS information when the LTE scheme which currently corresponds to the prioritized scheme is set as the setting scheme, the processor 33 switches the prioritized scheme from the LTE scheme to the 1x scheme. In this case, when a predetermined condition is satisfied, the processor 33 returns the prioritized scheme from the 1x scheme to the LTE scheme. The predetermined condition refers to that, for example, the signal including the ETWS information described above is not received within the predetermined period of time in the 1x scheme. A starting point of the predetermined period of time, that is, a reference timing corresponds to a switching timing when it is immediately after switching from the LTE scheme to the 1x scheme. Also, when the signal including the emergency information is received until the predetermined time elapses after the switching timing, the reception time point becomes a new reference timing. Also, for example, the processor 33 sets a timer (not illustrated) for a predetermined time to manage the predetermined period of time. Further, the signal which includes the ETWS information in the LTE scheme may be either one of the primary notification, the secondary notification, or both the primary notification and the secondary notification. Furthermore, the signal which includes the ETWS information is transmitted as a broadcast SMS in the 1x scheme.

For example, the processor 33 sets the predetermined time, that is, the length of the predetermined period of time, according to the type of the ETWS information. Also, the processor 33 updates a starting point of the predetermined period, that is, the reference timing, each time when the signal which includes the ETWS information is received according to the setting scheme. That is, the processor 33 resets the timer (not illustrated) for a predetermined time each time when the signal which includes the ETWS information is received.

Further, in a case where the communication device that conforms to the setting scheme receives the signal which includes the ETWS information when the LTE scheme which currently corresponds to the prioritized scheme is set as the setting scheme, the processor 33 may switch the prioritized scheme to the 1x scheme or the EVDO scheme. Accordingly, the packet communication may be continued.

[Example of Communication System Operation]

An exemplary operation of the communication system 1 having the configuration as described above will be described.

<ETWS>

When an earthquake or a tsunami occurs, the ETWS center 91, with regard to the LTE scheme, causes the MME 72 to generate and transmit paging message including ETWS notification to the LTE base station 20 first. Then, the paging message is broadcasted to the LTE base station 20 and thus, the terminal 30 is able to receive the paging message including the ETWS notification. Next, the ETWS center 91 causes the MME 72 to generate the primary notification and the secondary notification, and to transmit the primary notification and the secondary notification to the LTE base station 20 in the order of generating notification or simultaneously. Also, the primary notification is broadcasted from the LTE base station 20 by being included in SIB 10. Furthermore, the secondary notification is broadcasted from the LTE base station 20 by being included in SIB 11. Accordingly, the terminal 30 is able to receive specific information regarding an emergency.

With regard to the 1x scheme, the ETWS center 91 transmits information included in the primary notification and the secondary notification to the MC 51 within the 1x network 2 and causes the MC 51 to generate a SMS including the information. The SMS is transmitted to the 1x/EVDO base station 10 through the MSC 53 and broadcasted to the terminal 30 by the 1x/EVDO base station 10. Accordingly, the terminal 30 is able to receive specific information regarding an emergency.

The configuration of the primary notification and the secondary notification will be described hereinafter.

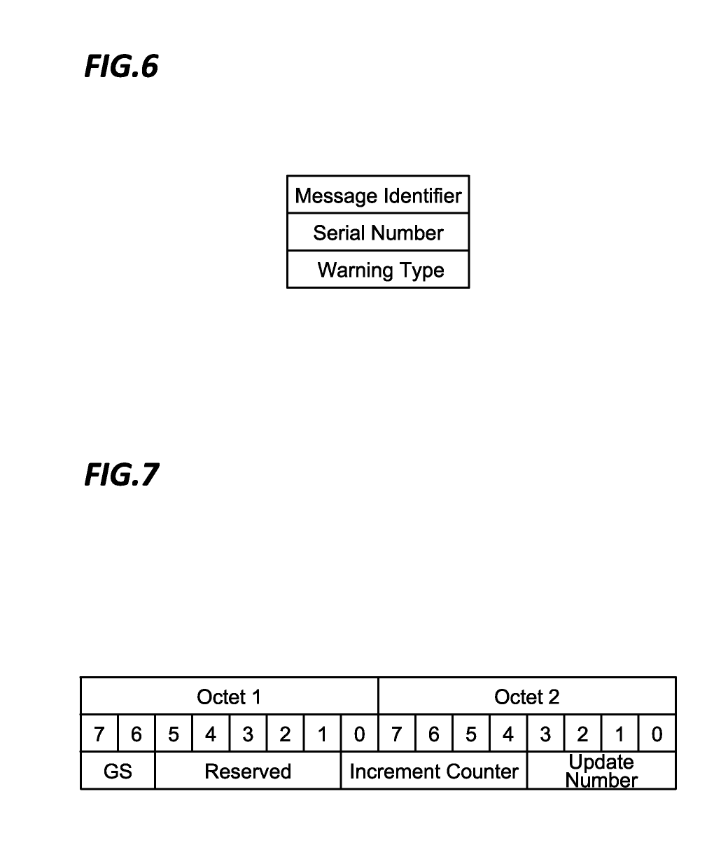

FIG. 6 is a diagram illustrating an example of a configuration of a primary notification. In FIG. 6, the primary notification includes a Message ID (Identifier) field, a Serial Number field, and a Warning Type field.

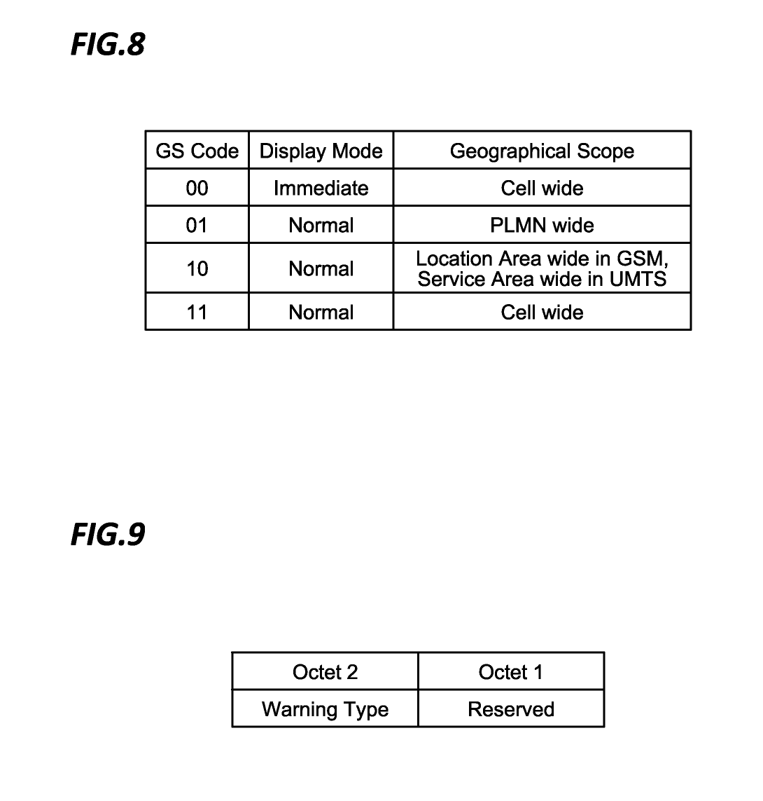

FIG. 7 is a diagram for explaining a configuration of a serial number. As illustrated in FIG. 7, the serial number is represented by two bytes (that is, 16 bits). For example, the first two bits indicate a GS (Cell wide Geographical Scope) code. The GS code, as illustrated in FIG. 8, indicates whether an area to which the primary notification is transferred is in a cell range or a location range, and as to whether the content of the primary notification is to be displayed in a pop up display. FIG. 8 is a diagram illustrating a usage example of a GS code.

Referring back to FIG. 7, five bits after the GS code is defined as the reserved bits, and five bits after the reserved bits indicates a counter value (that is, Increment Counter). These 10 bits are used as, for example, a message code. In particular, the terminal 30 which has received the primary notification according to the Increment Counter may determine whether the received primary notification has the same content as that of the primary notification received previously or is a primary notification received for the first time. Also, the last four bits in the serial number indicate an update number.

FIG. 9 is a diagram illustrating an example of a configuration of a warning type. As illustrated in FIG. 9, the warning type is represented by two bytes (that is, 16 bits). In particular, the first one byte indicates a warning type and the remaining 1 byte is defined as reserved bits.

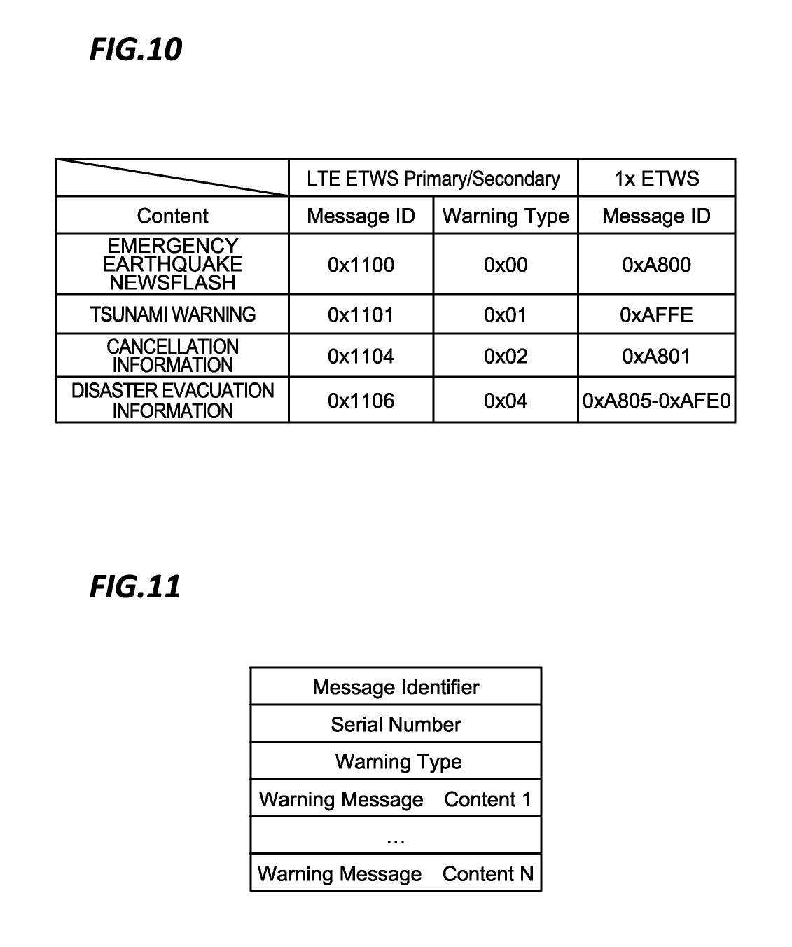

FIG. 10 is a diagram for explaining a usage example of a message ID and the warning type. As illustrated in FIG. 10, in the ETWS information according to the LTE scheme, each combination of a message ID and a warning type is associated with the content of message. Also, the terminal 30 may determine whether the message is for example, “emergency earthquake newsflash,” “tsunami warning,” “cancellation notification,” or “disaster evacuation information,” based on the message ID and the warning type included in the primary notification. Descriptions for the secondary notification are the same as in the primary notification. Further, as illustrated in FIG. 10, in the ETWS information according to the 1x scheme, the content of message may be represented by only a message ID.

FIG. 11 is a diagram illustrating an example of a configuration of a secondary notification. In FIG. 11, the secondary notification includes a Message ID field, a Serial Number field and a Warning Type field, similarly to the primary notification. However, unlike the primary notification, the secondary notification includes a content of message (that is, Warning Message Content).

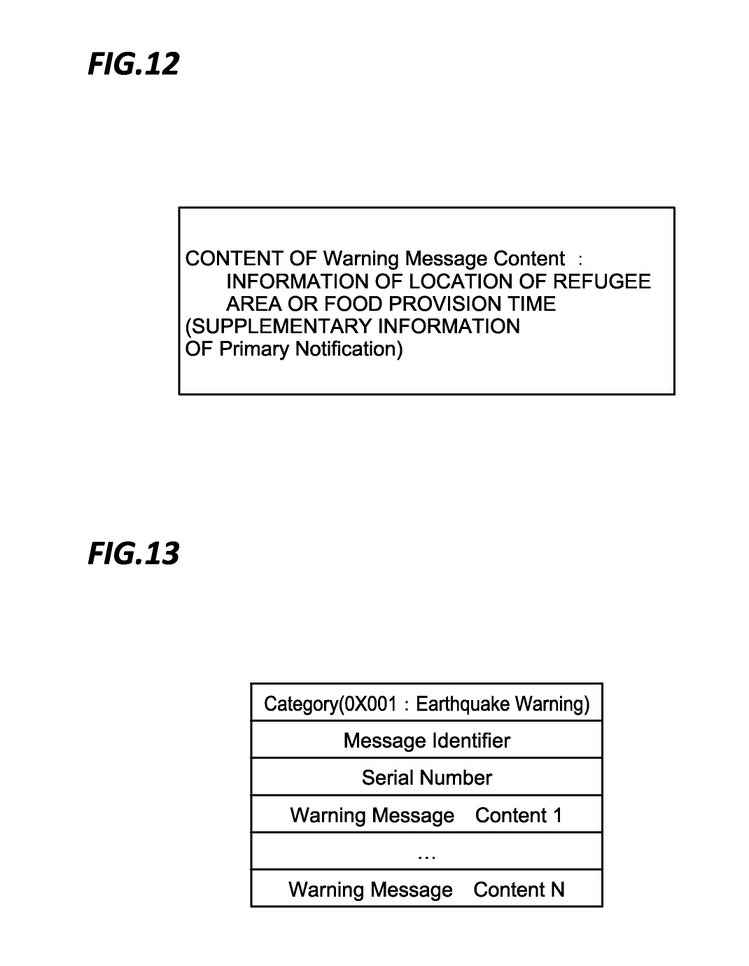

FIG. 12 is a diagram illustrating an example of the message content. As illustrated in FIG. 12, the message content is information which supplements the primary notification and, for example, information regarding the location of refugee area or food provision time.

An example of a broadcast SMS configuration will be described next. FIG. 13 is a diagram illustrating an example of a configuration of a broadcast SMS. The broadcast SMS includes a category field, a message ID field, a Serial Number field, and a message content (that is, Warning Message Content) field. The message ID, the Serial Number, and the message content are basically the same as those of the secondary notification as described above. “0x001” is set as category information in order to indicate that the broadcast SMS is for the ETWS information. Further, the broadcast SMS corresponds to a signal including the ETWS information in the 1x scheme.

<Processing Operations of Terminal>

The processing operations of the terminal 30 will be described next. In the following, the processing operations descriptions will be mainly made for a case where the terminal 30 is located within the LTE coverage area.

It is assumed that an earthquake occurs in a state where the terminal 30 is not connected to the 1x/EVDO base station 10 while being connected to the LTE base station 20.

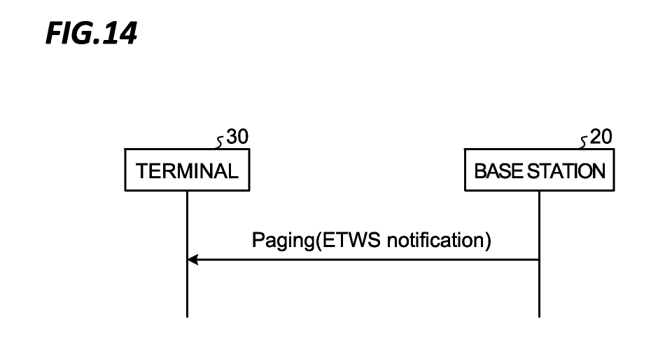

In this case, as illustrated in FIG. 14, the paging message which includes the ETWS notification generated by the MME 72 according to instruction issued from the ETWS center 91 is transmitted from the LTE base station 20, and the terminal 30 receives the paging message (that is, PI) according to the LTE scheme. FIG. 14 is a diagram for explaining transmission of the paging message including an ETWS notification.

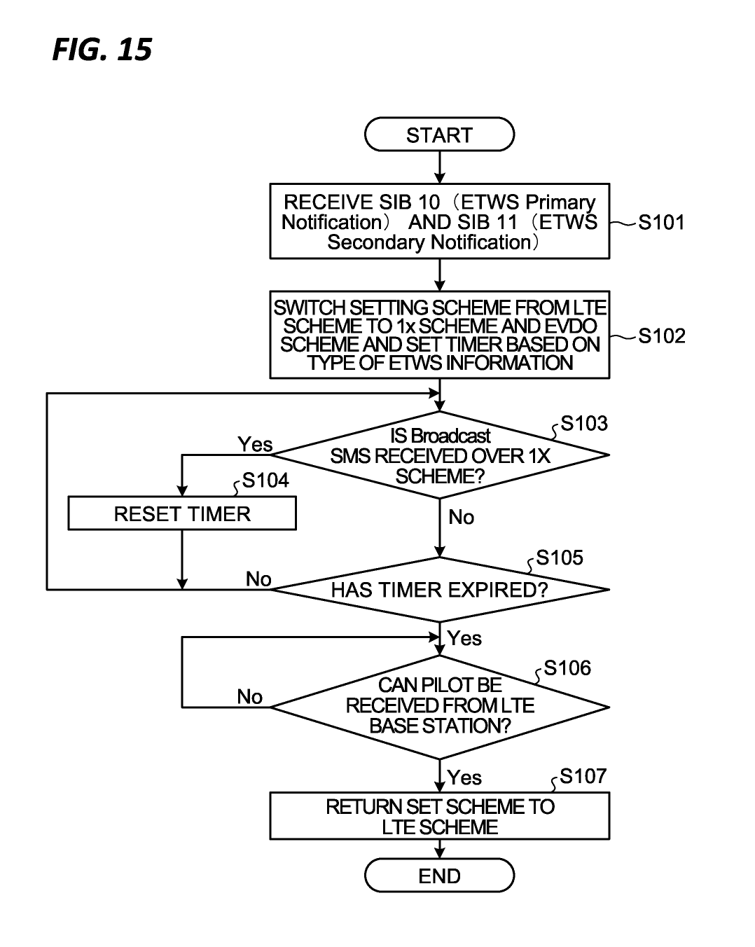

When the terminal 30 receives the paging message including the ETWS notification in the 1x scheme, the flow illustrated in FIG. 15 starts. FIG. 15 is a flowchart illustrating an example of processing operations of the terminal of the embodiment 2.

The processor 33 of the terminal 30 receives SIB 10 and SIB 11 (step S101).

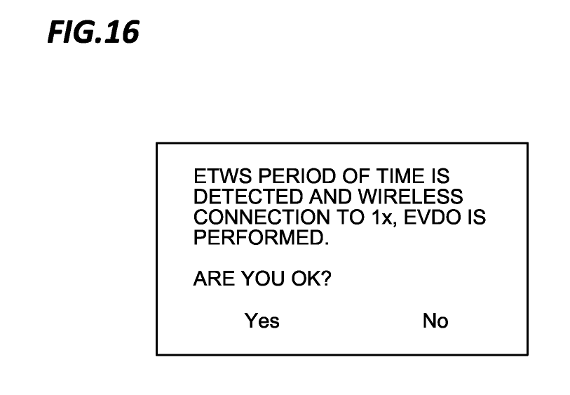

The processor 33 switches the setting scheme from the LTE scheme to the 1x scheme and EVDO scheme, and sets the timer based on the type of the ETWS information obtained by reception of, for example, SIB 10 (step S102). Here, the switching of the setting scheme from the LTE scheme to the 1x scheme and the EVDO scheme is resulted from a switching of the prioritized scheme from the LTE scheme to the 1x scheme and the EVDO scheme, which is caused by receiving of the SIB 10 and SIB 11. That is, in a case where the prioritized scheme is switched from the LTE scheme to the 1x scheme and the EVDO scheme, when the terminal 30 is located in the 1x service area, the setting scheme is also switched from the LTE scheme to the 1x scheme and the EVDO scheme. Here, when the service area of the 1x scheme is a nationwide coverage area, the setting scheme of all the terminals 30 throughout the country becomes the 1x scheme. Further, the processor 33 may display the content as illustrated in FIG. 16 on the display unit 36 before switching the setting scheme to the 1x scheme and the EVDO scheme. In the case, the processor 33 may perform switching on condition that a signal which indicates agreement on the switching according to manipulation of manipulation unit 37 by the user who saw the display is received. FIG. 16 is a diagram illustrating an example of contents displayed on a display unit.

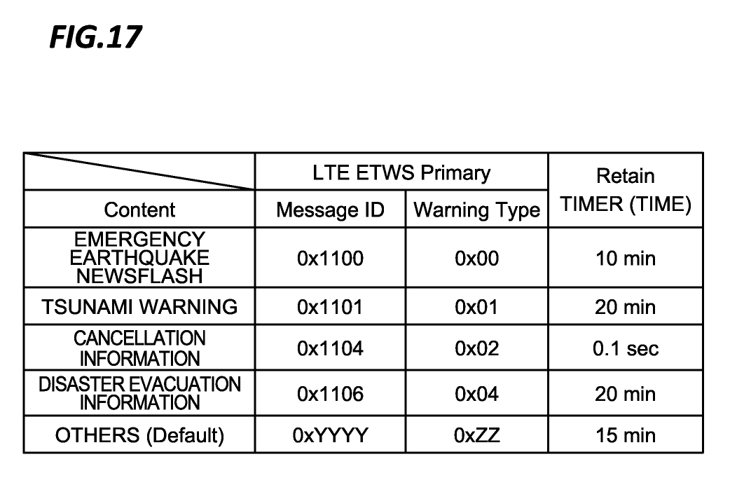

For example, as illustrated in FIG. 17, an association table in which a plurality of candidates corresponding to contents of messages and a timer setting value according to each candidate are associated with each other is maintained in the memory 34. FIG. 17 is a diagram illustrating an example of the association table. Also, the processor 33 sets a timer (not illustrated) at the timer setting value listed to be associated with the type of the message content included in the primary notification in the association table. For example, when the content of the message included in the primary notification is an emergency earthquake newsflash, the processor 33 sets the timer at 10 minutes. Here, the cancellation notification in FIG. 17 is information notifying that the previous notification is erroneous notification to be cancelled out. Further, the timer setting value is set according to the type of the ETWS information, but the timer setting value is not limited thereto, and may be set at a fixed value irrespective of the type of the ETWS information.

Referring back to FIG. 15, the processor 33 determines whether the broadcast SMS including the ETWS information is received according to the 1x scheme (step S103). The determination process is performed at regular time intervals.

When it is determined that the broadcast SMS including the ETWS information is newly received (“YES” at step S103), the processor 33 resets the timer (step S104). That is, the processor 33 updates the timer setting value. Thereafter, the process flow goes back to step S103.

When it is determined that the broadcast SMS including the ETWS information is not newly received (“NO” at step S103), the processor 33 determines whether the timer has expired (step S105).

When it is determined that the timer has expired (“YES” at step S105), the processor 33 turns ON the LTE communication device 32 and determines whether a pilot signal (that is, a known signal) transmitted from the LTE base station 20 can be received according to the LTE scheme (step S106). The reason why determination as to whether the pilot signal can be received according to the LTE scheme is performed is that the prioritized scheme is returned from the 1x scheme and the EVDO scheme to the LTE scheme due to expiration of the timer. That is, the processor 33 determines whether the terminal 30 is located within the coverage area of the LTE base station 20. Further, the LTE base station 20 which is a transmission-source of the pilot signal may be an LTE base station 20 to which the terminal 30 is connected before the setting scheme is switched from the LTE scheme to the 1x scheme and the EVDO scheme, otherwise may be another LTE base station 20. In the meantime, when it is determined that the timer has expired (“NO” at step S105), the process flow goes back to step S103.

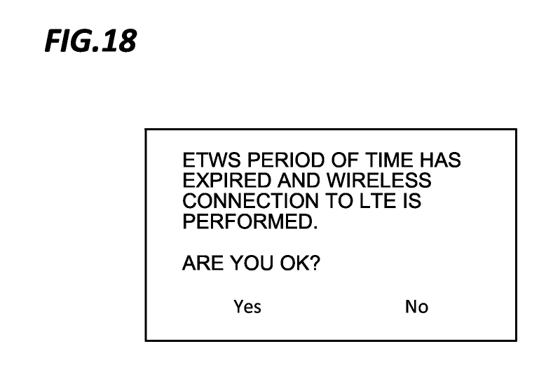

When it is determined that the pilot signal from the LTE base station 20 can be received (“YES” at step S106), the processor 33 performs a process which returns the setting scheme from the 1x scheme and the EVDO scheme to the LTE scheme (step S107). In the meantime, when it is determined that the pilot signal from the LTE base station 20 cannot be received (“NO” at step S106), the processor 33 keeps the setting scheme as the 1x scheme and the EVDO scheme until the pilot signal can be received from the LTE base station 20. Further, the processor 33 may display the content as illustrated in FIG. 18 on the display unit 16 before returning the setting scheme to the LTE scheme and return the setting scheme on condition that a signal which indicates agreement on the returning according to manipulation of manipulation unit 37 by the user is received. FIG. 18 is a diagram illustrating an example of contents displayed on the display unit.

Here, the processor 33 does not perform a system switching based on the pilot signal transmitted from the base stations 10, 20 until the timer expires after the ETWS information is received and the prioritized scheme is switched to the 1x scheme. That is, the processor 33 gives a higher priority to keeping the 1x scheme than performing the normal system switching. Accordingly, the occurrence frequency of system switching may be reduced. Also, the processor 33 may wait for the emergency information after reducing the occurrence frequency of the system switching and thus, the emergency information may be stably received, and the reception failure of the emergency information may be prevented.

Furthermore, the processes of steps S103-S105 are repeated as long as a new broadcast SMS is received until the timer expires.

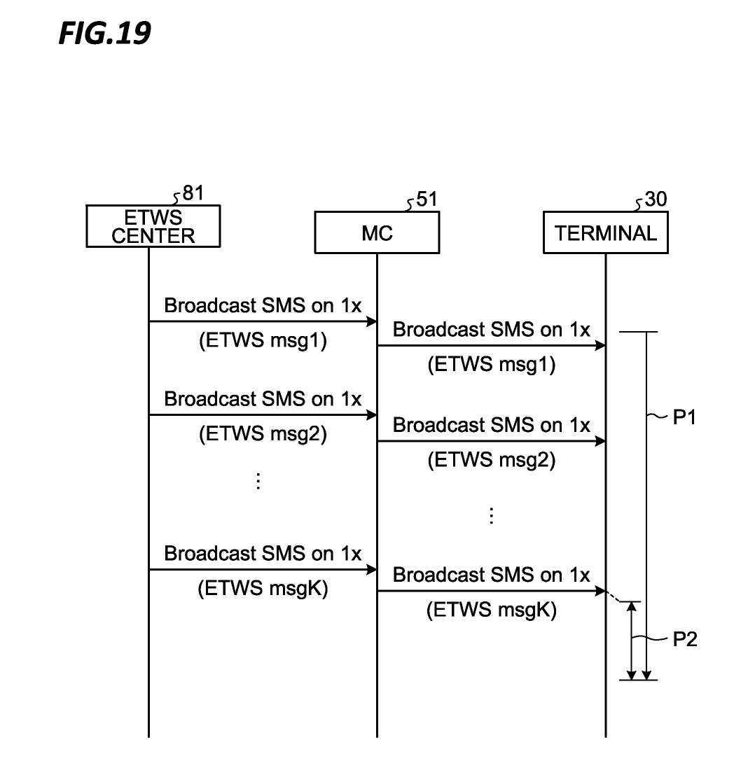

FIG. 19 is a diagram for explaining a timer update. As illustrated in FIG. 19, the terminal 30 repeats the timer update while the broadcast SMS is received until the timer expires. Also, when the broadcast SMS is not newly received until a predetermined time (P2 in FIG. 19) elapses from the reception time of the last received broadcast SMS (a broadcast SMS to which ETWS msg K is appended in FIG. 19), the timer update is ended. That is, a time period during which the timer operates is a time period of P1 in FIG. 19. A determination as to whether the setting scheme is returned to the LTE scheme is performed at an end point of the time period of P1.

As described above, according to the embodiment, in a case where a signal which includes the ETWS information is received by the communication device which conforms to the setting scheme when the prioritized scheme is the LTE scheme, the processor 33 of the terminal 30 switches the prioritized scheme from the LTE communication scheme to the 1x scheme.

With such a configuration of the terminal 30, since the terminal 30 preferentially switches to the 1x scheme having a larger service area, it is possible to reduce the occurrence frequency of system switching which makes a connection state unstable. Also, it is possible to wait for the ETWS information after reducing the occurrence frequency of the system switching and thus, the ETWS information may be stably received and the reception failure of the ETWS information may be prevented. Furthermore, even when a calamity such as an earthquake occurs, there is a need that makes it easier to receive a phone call from a relative or a friend. It takes a lot of time for an incoming call notification by the paging signaling of the LTE scheme. Therefore, when the ETWS information is received according to the LTE scheme which is for exclusive use of the packet communication, it is preferable to switch the communication to the 1x scheme having a larger service area and enabling voice speech.

Furthermore, when a predetermined condition is satisfied, the processor 33 returns the prioritized scheme from the 1x scheme to LTE scheme. The predetermined condition indicates that the signal including the emergency information is not received for the predetermined period of time, as described above.

With the configuration of the terminal 30, when the ETWS information is not received, the terminal 30 returns to the LTE scheme having a faster communication speed. Accordingly, the inconvenience caused by being remained in the 1x scheme having a lower communication speed may be prevented.

Furthermore, the processor 33 sets the length of the predetermined period of time according to the type of the ETWS information. Accordingly, for example, the predetermined period of time according to an importance level (e.g., a degree of risk or a degree of urgency) for each type of ETWS information may be set and thus, the possibility that the reception failure of emergency information having a high degree of importance occurs may be reduced. Furthermore, for example, when the type of the ETWS information is a cancellation notification, the terminal 30 may start a process of returning to the LTE scheme in 0.1 second.

Furthermore, the processor 33 updates the starting point of the predetermined period of time each time when the signal (that is, a broadcast SMS) which includes the ETWS information is received in the 1x scheme. Accordingly, it is possible to set up a standby state for the signal which includes next ETWS information having a high chance of becoming received. Further, for example, the length of the predetermined period of time together with the starting point may also be updated when the type of the ETWS information is varied in a series of plurality of broadcast SMSs which include the ETWS information.

### Modified Example

A modified example of the processing operation of the terminal 30 will be described next. Also, in the following, descriptions of the processing operation will be made mainly on a case where the terminal 30 is located within the LTE coverage area. For example, the processor 33 of the terminal 30 may switch the prioritized scheme based on a correspondence relationship between a plurality of communication schemes and a priority level of each communication scheme. Also, the correspondence relationship becomes reversed before and after receiving, for example, a signal which includes the ETWS information.

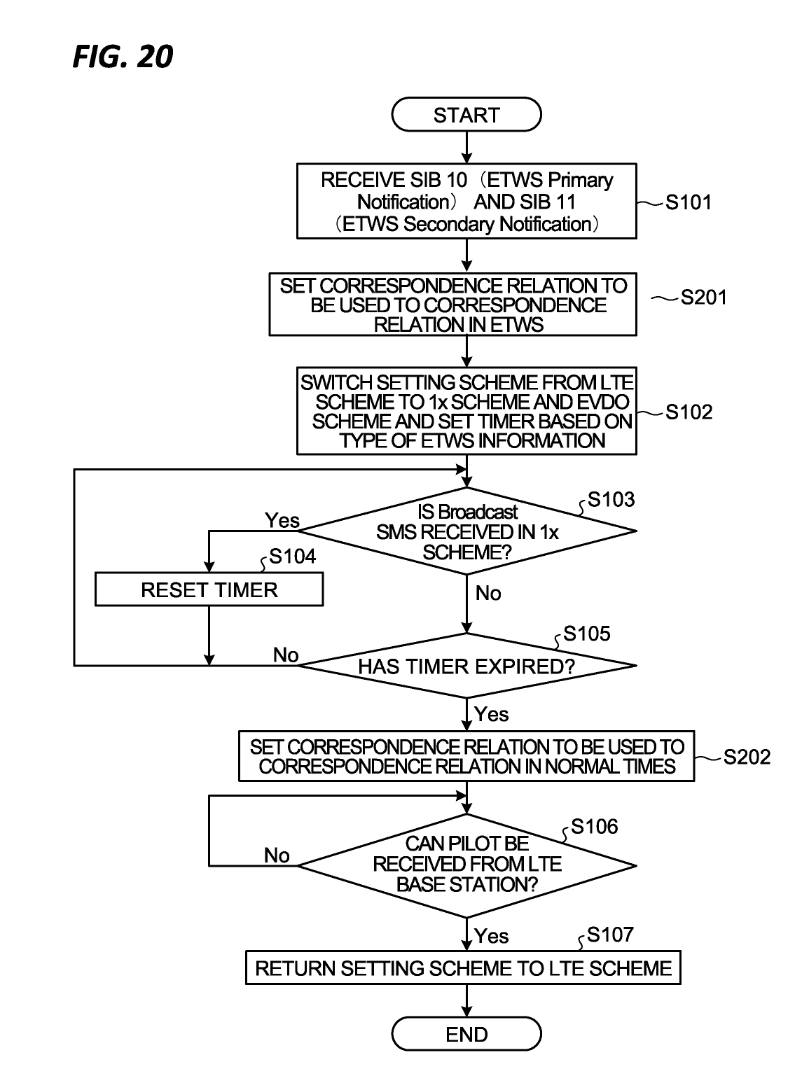

FIG. 20 is a flowchart illustrating a modified example of processing operation of the terminal.

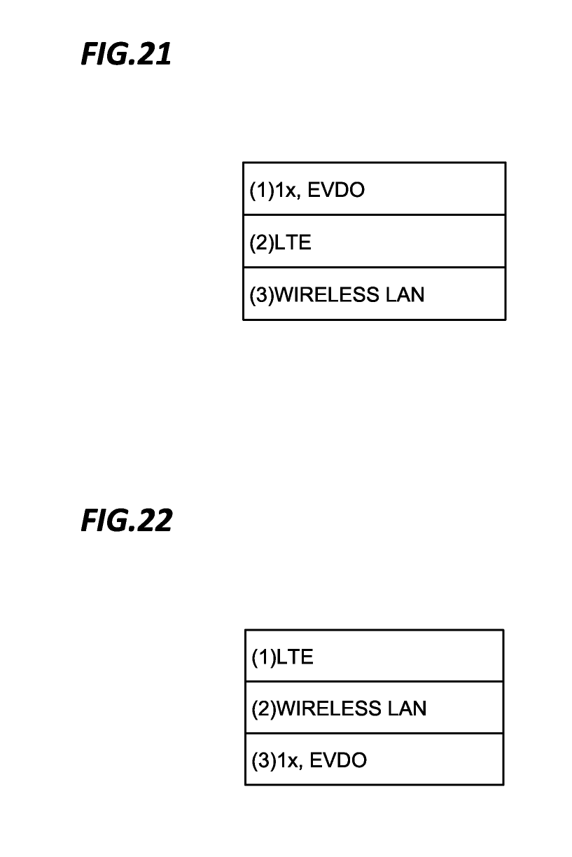

The processor 33 of the terminal 30 sets the correspondence relationship upon receiving the ETWS information as the correspondence relationship used for switching of the prioritized scheme (step S201). FIG. 21 is a diagram illustrating an example of the correspondence relationship upon receiving the ETWS information. As illustrated in FIG. 21, in the correspondence relationship upon receiving the ETWS information, the priority level is set in such a manner that the 1x scheme and the EVDO scheme have the highest priority level, the LTE scheme has the next higher priority level, and the wireless LAN scheme has the lowest priority level. Therefore, at step S102, the processor 33 switches the setting scheme from the LTE scheme to the 1x scheme and the EVDO scheme having the highest priority level. This is resulted from switching of the prioritized scheme from the LTE scheme to the 1x scheme and the EVDO scheme having the highest priority level.

Furthermore, when the timer expires (“YES” at step S105), the processor 33 sets the correspondence relationship in normal times as the correspondence relationship used for switching of the prioritized scheme (step S202). FIG. 22 is a diagram illustrating an example of the correspondence relationship in normal times. As illustrated in FIG. 22, in the correspondence relationship in normal times, the priority level is set in such a manner that the LTE has the highest priority level, the wireless LAN scheme has the second highest priority level, and the 1x scheme and the EVDO scheme have the third highest priority level. That is, the correspondence relationship upon receiving the ETWS information is different from the correspondence relationship in normal times in the order of the priority levels.

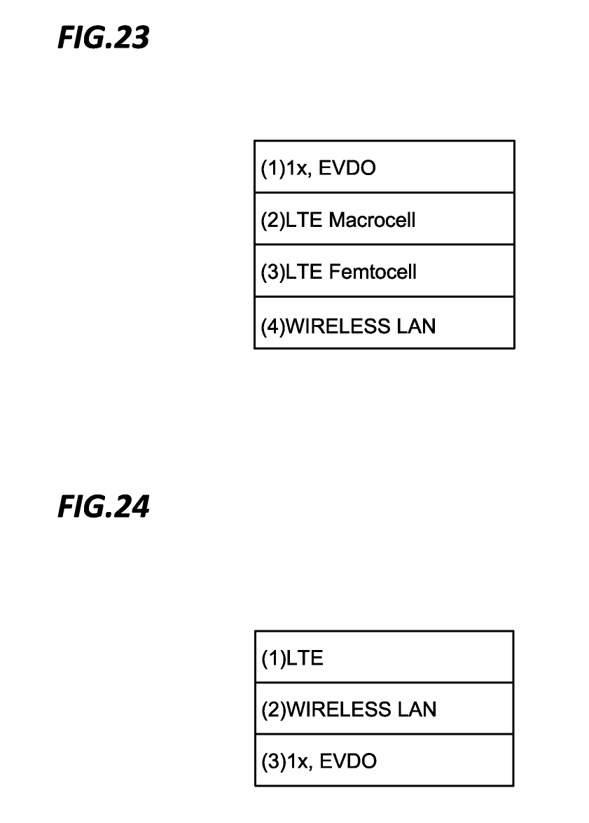

Further, the LTE scheme is not particularly classified in FIG. 21 and FIG. 22, but may be classified into two types, for example, LTE macrocell and the LTE femtocell as in FIG. 23 and FIG. 24. FIG. 23 is a diagram illustrating a modified example of the correspondence relationship upon receiving the ETWS information. FIG. 24 is a diagram illustrating a modified example of the correspondence relationship in normal times.

### OTHER EMBODIMENTS

[1] The terminal 30 described in the embodiment 1 and the embodiment 2 may be a smart phone, a tablet terminal, or an information terminal. As a result, the terminal 30 may be able to support multiple wireless communications.

[2] Each constitutional element of each unit illustrated in the embodiment 1 and the embodiment 2 does not need to have a configuration that is physically conformed to the illustrated one. That is, a specific form of distribution and integration of each unit is not limited to the illustrated form, and some or all of the elements may be configured by being functionally or physically distributed and integrated in any configuration unit according to a variety of loads or use condition.

Furthermore, some or all of various processing functions performed in each apparatus may be executed on CPU (Central Processing Unit) ((or a microcomputer such as MPU (Micro Processing Unit), MCU (Micro Controller Unit)). Furthermore, various processing functions may be executed on a program interpreted and executed by the CPU (or a microcomputer such as MPU MCU) or a hardware configured by a wired logic.

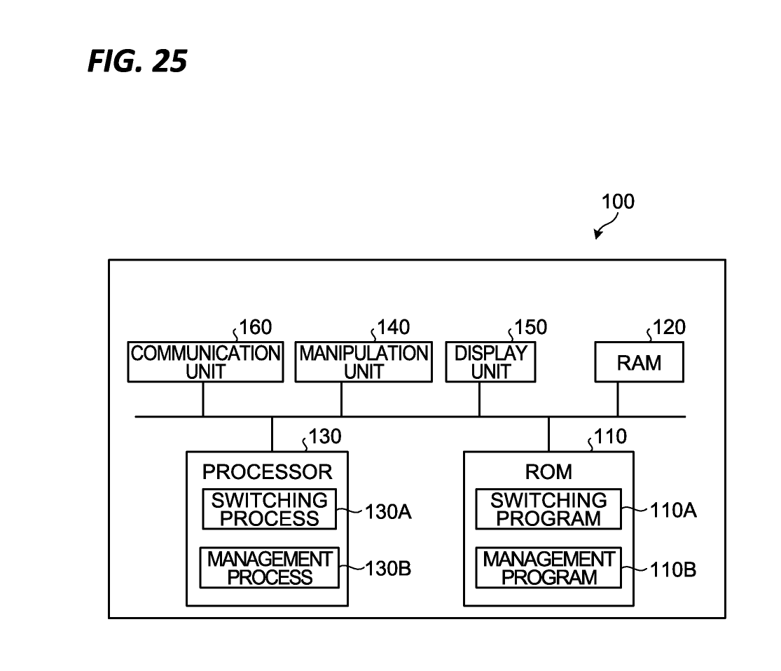

In the meantime, a program prepared in advance may be executed to implement various processing functions described in the embodiment 1 and the embodiment 2. Accordingly, in the following, an example of the terminal which executes the program having the same function as those in the embodiment 1 and the embodiment 2 will be described. FIG. 25 is an explanatory diagram illustrating a terminal 100 which executes a control program.

In FIG. 25, the terminal 100 which executes the control program includes a ROM 110, a RAM 120, a processor 130, a manipulation unit 140, a display unit 150, and a communication unit 160. Also, the control program which implements the same functions as those in the embodiment 1 and the embodiment 2 is stored in the ROM in advance. Further, the control program may be recorded in a drive (not illustrated) readable recording medium other than the ROM 110. Furthermore, the recording medium may include, for example, a portable recording medium such a CD-ROM, a DVD disk, a USB memory, a SD card, or a semiconductor memory such as a flash memory. The control program includes a switch program 110A and a management program 110B as illustrated in FIG. 25. Further, the programs 110A and 110B may be appropriately integrated or distributed.

Also, the processor 130 reads the programs 110A and 110B from the ROM 110 and executes each read program. Also, the processor 130 executes the program 110A and program 110B to function as a switch process 130A and a management process 130B, respectively. The communication unit 160 has a multiple wireless communication functions operable in a plurality of communication schemes including the LTE scheme and the 1x scheme.

In a case where a signal which includes the ETWS information is received by the communication unit 160 when a prioritized scheme is the LTE scheme, the processor 130 switches the prioritized scheme from the LTE scheme to the 1x scheme. The processor 130 manages a determination timing used for determining as to whether the prioritized scheme is to be returned from the 1x scheme to the LTE scheme. When a predetermined condition is satisfied for the determination timing, the processor 130 returns the prioritized scheme from the 1x scheme to the LTE scheme.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication terminal comprising:
a communication device configured to conform to first and second communication schemes, the second communication scheme enabling communication at a higher communication speed than the first communication scheme and having a narrower service area than the first communication scheme; and
a processor connected to the communication device, the processor being configured
to switch a prioritized scheme from the second communication scheme to the first communication scheme in a case where some of a plurality of signals including emergency information and sequentially notified according to each of the first and second communication schemes are received by the communication device when the prioritized scheme to be preferentially used is the second communication scheme, and
to return the prioritized scheme from the first communication scheme to the second communication scheme in a case where the signal is not received for a predetermined time period in the first communication scheme.

2. The communication terminal of claim 1, wherein
the processor is configured to set a length of the predetermined period of time according to a type of the emergency information.

3. The communication terminal of claim 1, wherein
the processor is configured to update a starting point of the predetermined period each time when the signal is received according to the first communication scheme.

4. The communication terminal of claim 1, wherein
the second communication scheme is a communication scheme for an exclusive use of a packet communication;
the communication device is further configured to conform to a third communication scheme which has a larger service area than that of the second communication scheme and is for an exclusive use of the packet communication; and
the processor is configured to switch the prioritized scheme to the first communication scheme and the third communication scheme in a case where some of the plurality of signals are received when the prioritized scheme is the second communication scheme.

5. A method performed by a communication terminal that communicates using first and second communication schemes, the second communication scheme enabling a communication at a higher communication speed than the first communication scheme and having a narrower service area than the first communication scheme, the method comprising;
switching a prioritized scheme from the second communication scheme to the first communication scheme in a case where some of a plurality of signals including emergency information and sequentially notified according to each of the first and second communication schemes are received when the prioritized scheme to be preferentially used is the second communication scheme; and
returning the prioritized scheme from the first communication scheme to the second communication scheme in a case where the signal is not received for a predetermined time period in the first communication scheme.

6. A computer-readable recording medium having stored therein a program for causing a computer to perform a procedure, the computer being included in a communication terminal that communicates using first and second communication schemes, the second communication scheme enabling a communication at a higher communication speed than the first communication scheme and having a narrower service area than the first communication scheme, the procedure comprising:
switching a prioritized scheme from the second communication scheme to the first communication scheme in a case where some of a plurality of signals including emergency information and sequentially notified according to each of the first and second communication schemes are received when the prioritized scheme which is to be preferentially used is the second communication scheme; and
returning the prioritized scheme from the first communication scheme to the second communication scheme in a case where the signal is not received for a predetermined time period in the first communication scheme.
